(19) United States
(12) Patent Application Publication
(10) Pub. No.: US 2015/0123418 A1
(43) Pub. Date: May 7, 2015

(54) LIFTING DEVICE, SYSTEM AND ASSOCIATED METHODS

(71) Applicant: Wear Applications and Management Services Pty Ltd., Hexham NSW (AU)

(72) Inventor: Ronald Thomas Bell, Hexham NSW (AU)

(21) Appl. No.: 14/522,727

(22) Filed: Oct. 24, 2014

(30) Foreign Application Priority Data
Nov. 1, 2013 (AU) 2013904224

(51) Int. Cl. B66C 1/66

(52) U.S. Cl. CPC B66C 1/66
USPC 294/215; 428/131

(57) ABSTRACT

A device (10,110) for lifting a structure (59) having an aperture (62) therein, the device (10,110) including a body (12, 112) adapted to locate the device (10,110) relative to the aperture (62) of the structure (59) and a pin (18, 118) moveably receivable by a bore (16, 116) of the body (12, 112), the pin (18, 118) including a foot (22, 122) which is arranged to pass through the aperture (62) of the structure (59) in a first orientation and be rotated to a second orientation such that the foot (22, 122) is engagable with the aperture (62) of the structure (59).

### TECHNICAL FIELD

The invention relates to a device for lifting a structure and a lifting system. The invention also relates to a plate for coupling with a lifting device, a method for forming the plate as well as a method of coupling a lifting device to a plate.

### BACKGROUND

The lifting of structures, such as plate structures, is often required. However, such plate structures are often awkward and difficult to move or lift. In particular, such plate structures are often stored flat with the plate structure lying on a surface such as a ground surface or being horizontally stacked on top of one another.

When lying on a surface, plate structures are particularly difficult to lift because there are limited ways to grip or engage the plate structure. One currently known way to engage such a plate structure is to lift a side edge of the plate structure and connect a set of clamping jaws, commonly known as dog jaws, to the side edge of the plate structure.

There are two main problems with this approach. Firstly, the edge of the lifting plate needs to be made accessible such as by being lifted or otherwise raised to allow the jaw to be attached to the side edge of the plate. This presents an operational and safety problems as a worker needs to move the plate structure and manually engage and disengage the jaws from the side edges of the plate structure.

The second problem is that the jaw may lose grip with the plate which presents a significant safety problem. This may be particularly problematic with a high hardness plate, such as a chrome iron plate, as the jaws may not have sufficient grip with the plate. Furthermore, if multiple jaws are used and not placed in the correct location the stability of the plate being lifted may be compromised.

The invention disclosed herein seeks to address the above identified problems or at least provide a useful alternative.

### SUMMARY

In accordance with a first main aspect there is provided, a device for lifting a structure having an aperture therein, the device including a body adapted to locate the device relative to the aperture of the structure and a pin moveably receivable by a bore of the body, the pin including a foot which is arranged to pass through the aperture of the structure in a first orientation and be rotated to a second orientation such that the foot is engagable with the aperture of the structure.

In one aspect, the body includes a locator arranged to be receivable by the aperture of the structure.

In another aspect, the locator and foot are each substantially elongate in shape and are oriented substantially perpendicular to one another.

In yet another aspect, the locator is shaped to fit with the aperture so as to inhibit rotation of the body relative to the structure.

In yet another aspect, the pin and the bore are adapted to fit with one another so as to inhibit rotation of the pin relative to the bore.

In yet another aspect, the body includes an outer body portion and an inner body portion rotatably coupled to the outer body portion, wherein the inner body portion includes the bore and the locator thereby allowing rotation of the bore and locator relative to the outer body portion.

In yet another aspect, the inner body portion and outer body portion are shaped to engage with one another at rotational limits thereby allowing limited relative rotation of the inner body portion and outer body portion between the rotational limits.

In yet another aspect, one of the bore and the pin includes a guide slot and the other of the bore and pin includes a lug received by the guide slot, the guide slot and lug being arranged to allow lengthwise slidable movement of the pin relative to the bore and inhibit rotation of the pin relative to the bore.

In yet another aspect, the device further includes an actuator coupled to the pin so as to move the pin lengthwise relative to the bore between a disengaged condition, in which pin is in an extended position and the foot is removable in the first orientation from the aperture of the structure, and an engaged condition, in which the pin is moved to a retracted position and the foot is movable in the second orientation into engagement with the aperture of the structure.

In yet another aspect, the actuator is a nut threadedly coupled to the pin.

In yet another aspect, the pin has a substantially elongate cylindrical shape and the foot includes wings which extend from opposing sides of the pin.

In yet another aspect, a lifting structure is coupled to the body.

In yet another aspect, the lifting structure has a wishbone shape with ends of the wishbone being pivotally coupled to opposing sides of the body such that the pin is accessible between the ends of the wishbone.

In yet another aspect, a length of the foot is longer than a diameter of the pin.

In yet another aspect, a width of the foot is narrower than a diameter of the pin.

In accordance with a second main aspect there is provided, a lifting system including a lifting device as defined above and a plate having an aperture therein, wherein the aperture is shaped to receive the foot of the pin in the first orientation and restrict the passage of the foot in the second orientation.

In one aspect, the aperture includes internal abutment surfaces which are arranged to be engagable with abutment surfaces of the foot in the second orientation.

In another aspect, the aperture includes an upper aperture portion shaped to fit with the locator of the body so as to locate the body relative to the plate, and a lower aperture portion shaped to allow rotation of the foot between the first orientation and the second orientation whilst the foot is received within the lower aperture portion.

In yet another aspect, the upper aperture portion is shaped to receive the body such that rotation of the locator relative to the plate is inhibited and wherein the internal abutment surfaces are provided on an underside of a throat defined between the upper aperture portion and lower aperture portion.

In accordance with a third main aspect there is provided, a plate for coupling with a device as defined above, the plate including a top surface, an underside surface and an aperture which extends between the top surface and the underside surface, wherein the aperture is adapted to allow passage of the foot in the first orientation and be engagable with the foot in the second orientation.

In one aspect, the aperture includes a throat arranged to allow passage of the foot in the first orientation and restrict passage of the foot in the second orientation in which the foot is engagable with an underside of the throat.

In one aspect, the aperture includes a receiving portion toward the top surface and a retaining portion located toward the bottom surface relative the receiving portion, wherein the receiving portion is arranged to receive the body so as to locate the body relative to the plate and the retaining portion is arranged to allow rotation of the foot between the first orientation and the second orientation whilst the foot is received within the lower aperture portion.

In another aspect, a throat is defined between the receiving portion and the retaining portion, the throat having abutment surfaces which are engageable with abutment surfaces of the foot in the second orientation.

In another aspect the retaining portion of the aperture includes abutment surfaces which are engageable with abutment surfaces of the foot in the second orientation.

In accordance with a fourth main aspect there is provided, a method of forming a plate as defined above, the method including the steps of inserting a plug shaped to define the aperture within a cast and filling the cast with material to form the plate.

In accordance with a fifth main aspect there is provided, a method of forming a plate as defined above, the method including the steps of using a tool to machine the aperture within the plate.

In accordance with a sixth main aspect there is provided, method for coupling a lifting device to a plate having an aperture therein, the lifting device including a body and a pin movably coupled to the body, the method including steps of: inserting the pin in a first orientation through the aperture of the plate; locating the body relative to the aperture so as to rotate the pin to a second orientation in which a foot of the pin is engagable with the aperture; moving an actuator coupled to the pin so as to move the foot into engagement with the aperture thereby coupling the lifting device to the plate.

In one aspect, the step of locating the body includes rotating the body to the second orientation such that a locator of the body is receivable in the aperture.

### BRIEF DESCRIPTION OF THE FIGURES

The invention is described, by way of non-limiting examples only, by reference to the accompanying figures, in which;

FIG. 1 is a top isometric view illustrating a lifting device with a lifting pin in a retracted position;

FIG. 2 is a bottom isometric view illustrating the lifting device with the lifting pin in the retracted position;

FIG. 3 is a top isometric view illustrating the lifting device with the lifting pin in an extended position;

FIG. 4 is a bottom isometric view illustrating the lifting device with the lifting pin in the extended position;

FIG. 5 is a side hidden detail view illustrating the lifting device with the lifting pin in the retracted position;

FIG. 6 is a side hidden detail view illustrating the lifting device with the lifting pin in the extended position;

FIG. 7 is a top isometric view illustrating a second example of a lifting device with a lifting pin in a retracted position;

FIG. 8 is a bottom isometric view illustrating the second example of the lifting device with the lifting pin in the retracted position;

FIG. 9 is a top isometric view illustrating the second example of the lifting device with the lifting pin in an extended position;

FIG. 10 is a bottom isometric view illustrating the second example of the lifting device with the lifting pin in the extended position;

FIG. 11 is a side hidden detail view illustrating the second example of the lifting device with the lifting pin in the retracted position;

FIG. 12 is a side hidden detail view illustrating the second example of the lifting device with the lifting pin in the extended position;

FIG. 13 is a front exploded parts view illustrating the second example of the lifting device;

FIG. 14a is a side view of the second example illustrating the lifting device;

FIG. 14b is a front sectional view of the second example illustrating the lifting device along section A-A as shown in FIG. 14a;

FIG. 15a is a underside perspective view illustrating an inner body part of the locating body of the second example of the device;

FIG. 15b is a topside perspective view illustrating an outer body part of the locating body of the second example of the device;

FIG. 16a is a top view illustrating the second example illustrating the lifting device;

FIG. 16b is top sectional view illustrating the second example illustrating the lifting device along section B-B as shown in FIG. 14a;

FIG. 17a is perspective view illustrating the lifting pin;

FIG. 17b is side view illustrating the lifting pin;

FIG. 17c is a front view illustrating the lifting pin;

FIG. 18 is a sectional side view illustrating a third example whereby the lifting device includes a curved bottom surface and an extended pin;

FIG. 19a is a topside perspective view illustrating a plate having an aperture therein;

FIG. 19b is a top view illustrating the plate having the aperture therein;

FIG. 20a is an underside perspective view illustrating the plate having the aperture therein;

FIG. 20b is a bottom view illustrating the plate having the aperture therein;

FIG. 21 is a side sectional view illustrating the aperture of the plate along section D-D as shown in FIG. 19b;

FIG. 22 is a side sectional view illustrating the aperture of the plate along section F-F as shown in FIG. 19b;

FIG. 23 is a perspective view illustrating a system including the device and the plate, the device being in a first orientation so as to allow the foot of the pin to be inserted into the aperture;

FIG. 24 is a side view illustrating the system with the pin of the device inserted into the aperture;

FIG. 25 is an underside perspective view illustrating the system with the device in a second orientation in an engaged condition in which the device is secured to the plate; and

FIG. 26 is a side view illustrating the system with the device in the second orientation in the engaged condition in which the device is secured to the plate.

### DETAILED DESCRIPTION

Referring to FIGS. 1 to 4, there is shown a lifting device 10 including a locating body 12, a lifting structure 14 and a lifting pin or bolt 18. The lifting structure 14 is pivotally coupled to the locating body 12 and the lifting pin 18 is moveably received by a bore 16 of the body 12 so as to pass through the body 12. The device 10 including the body 12, the pin 16 and the lifting device 14 may be made from a metal or steel material, preferably, high tensile steel.

The lifting pin 18 includes a first end 15 and a second end 17 between which a shank 24 extends. The shank 24 of the pin 18 may be cylindrical in shape having a circular or non-circular cross section.

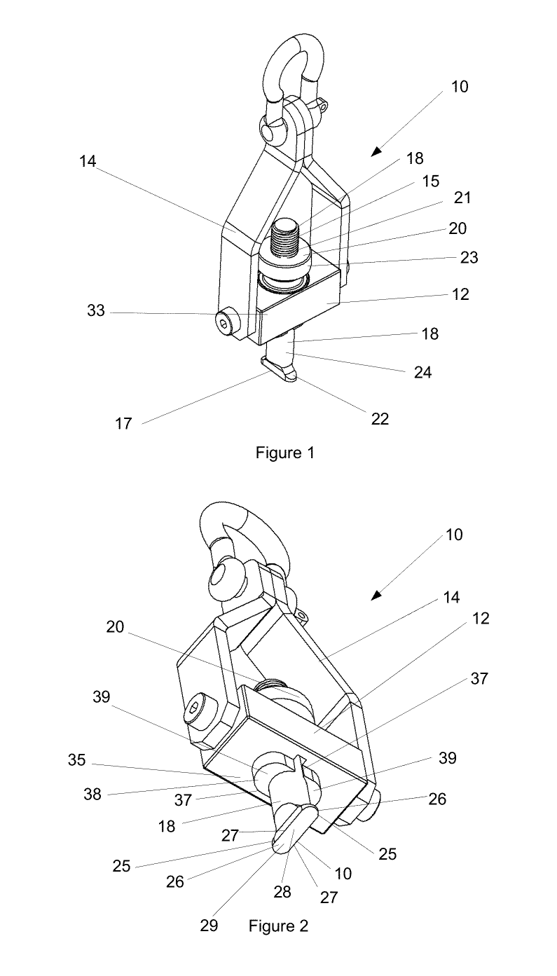

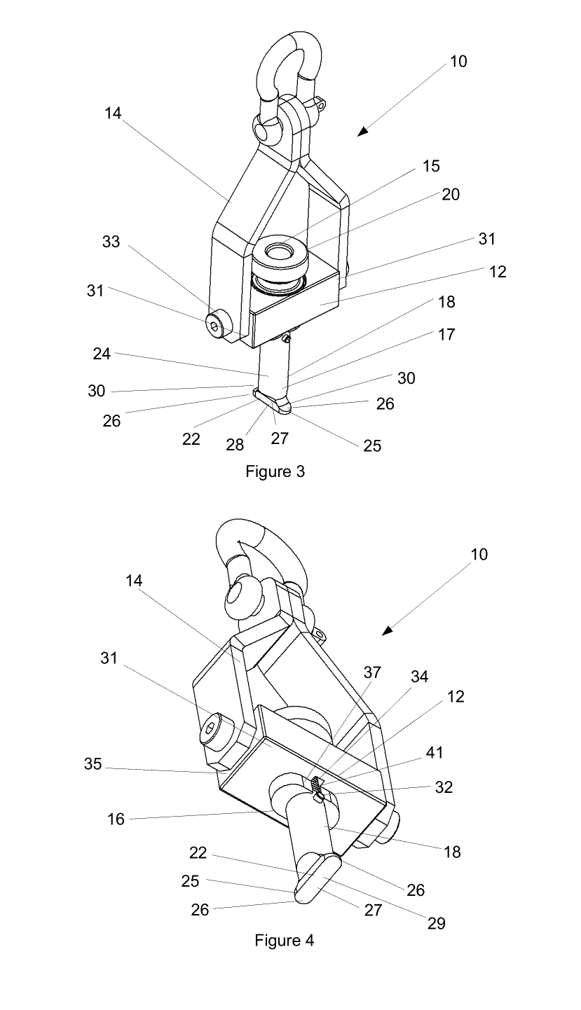

An actuator nut 20 is threadedly coupled to the first end 15 and the second end 17 includes a foot 22. The actuator nut 20 may be rotated to move the lifting pin 18 between a retracted position, as shown in FIGS. 1 and 2, and an extended position, as shown in FIGS. 3 and 4. The actuator nut 20 has a circular shape with a threaded through bore 21 and a skirting gripping surface 23 adapted for hand rotation of the actuator nut 20.

The foot 22 has a generally elongate shape having a central portion 28 and wings 26 extending from opposing sides of the central portion 28. The wings 26 provide the foot 22 with abutment surfaces 30. The free ends 25 of the wings 26 are rounded and the opposing sides 27 of the foot 22 are straight. The base 29 of the foot 22 presents a generally flat surface.

The length of the foot 22 between the free ends 25 of the wings 26 is greater than the diameter of the shank 24. The wings 26 of the foot 22, which provide the abutment surfaces 30, taper or chamfer inwardly to join the shank 24. The width of the foot 22 between the opposing sides 27 is narrower than the diameter of the shank 24 and the foot 22 tapers or chamfers outwardly from the opposing sides 27 to the shank 24.

The lifting pin 18 further includes a locating lug 32 which projects from a side wall of the shank 24 of the lifting pin 18. The locating lug 32 is slidably received in a corresponding guide slot 34 which extends lengthwise along an inner side wall of the centrally located bore 16.

The locating body 12 includes opposing sides 31 to which the lifting structure 14 is attached, a top side 33 adjacent which the actuator nut 20 is located and an underside 35 from which a projecting portion or locator 38 extends.

The bore 16 is centrally aligned with the locating body 12 and extends through the body 12 and the projecting portion 38. The projecting portion 38 has a generally elliptical or oval shape having an elongate axis which is generally perpendicular to the elongate axis of the foot 22. More specifically, the projecting portion 38 includes opposing sides 37 which extend between rounded or radiused ends 39. The overall length of the projecting portion 38 is similar to or slightly longer than the length of the foot 22. The width of the projecting portion 38 between the opposing sides 37 is similar to or slightly wider than the diameter of the bore 16 which extends through the projecting portion 38. One of the opposing sides 37 includes a gap 41 which aligns with and forms an extension of the guide slot 34. The gap 41 receives and allows passage of the lug 32 when the pin 18 is in the extended position. It is noted that under normal operation conditions the lug 32 remains within the guide slot 34 or the gap 41.

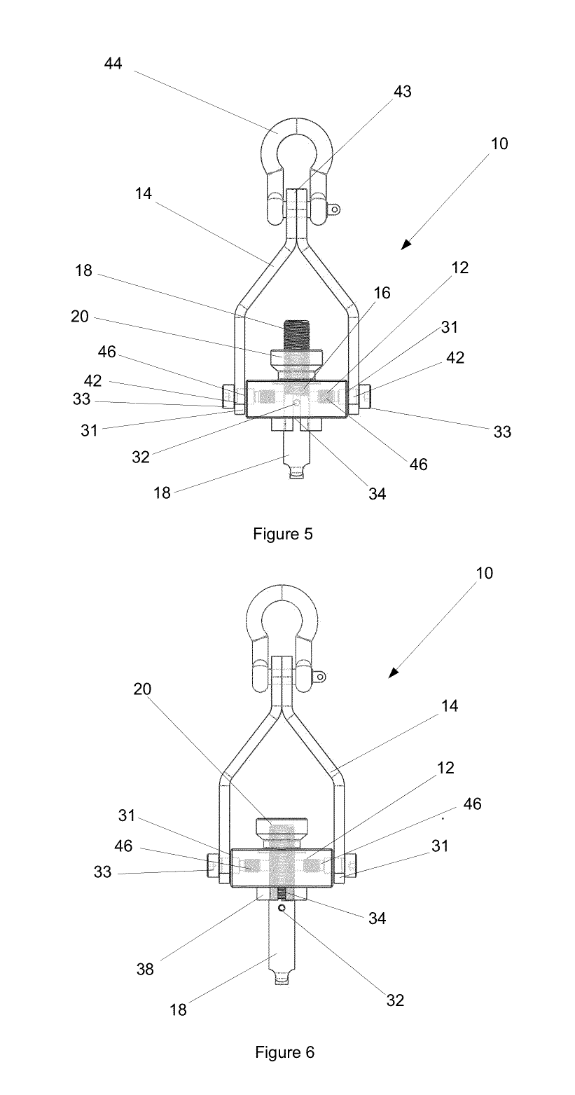

Referring now to FIGS. 5 and 6, the lifting structure 14 has a substantially wish bone shape and includes opposing free ends 42 and a central lifting point 43 from which the lifting device 10 may be lifted. In this example, a D-shackle 44 is coupled to the central lifting point 43 and may be used as a lifting point for the lifting device 10.

The opposing free ends 42 are pivotally coupled via threaded fasteners 33 with opposing sides 31 of the locating body 12. The body 12 includes threaded bores 46 which extend into each of the opposing sides 31 of the locating body 12. The threaded fasteners 33 are secured to the threaded bores 46 to pivotally couple the lifting structure 14 to the body 12. The space defined between the wishbone shape of the lifting structure 14, and the pivoting of the lifting structure 14, allows for access to the actuator 20. For example, the lifting structure 14 may be pivoted to one side to allow for easy access to the actuator 20.

The guide slot 34 extends through the body 12 and is arranged lengthwise along a side wall of the bore 16. The locating lug 32 is moveably slidable along the guide slot 34 between the retracted position in which the lug 32 is located internally of the body 12, as shown in FIG. 5, and the extended position as shown in FIG. 6, where the lug 32 is located in the projecting portion 38 (shown clear of the projecting portion 38 for illustrative purposes only).

The arrangement of the locating lug 32 and the corresponding guide slot 34 is such that the lifting pin 18 may undergo guided sliding movement in the axial direction. However, rotational movement between the lifting pin 18 and the locating block 12 is inhibited. The actuator nut 20 may be used to extend or retract the lifting pin 18 in the axial direction relative to the bore 16.

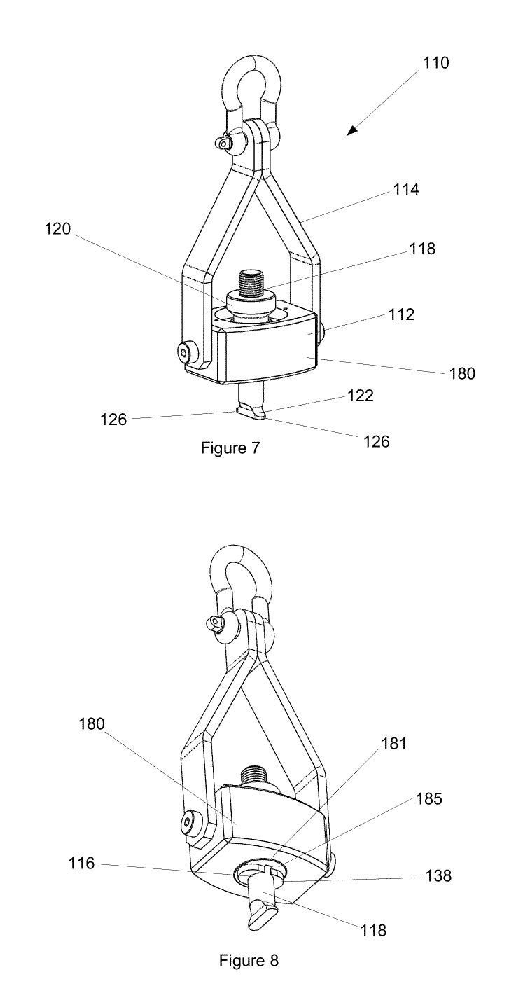

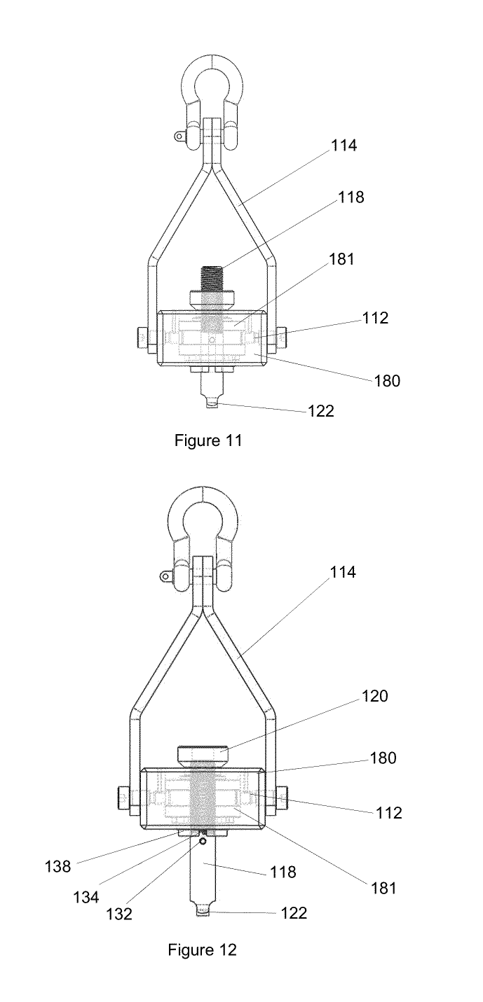

Referring now to FIGS. 7 to 13, there is shown a second example of the lifting device 110 in which like sequences of numerals relate to like or similar parts. For example, locating body 112 relates to locating body 12, and lifting structure 114 relates to lifting structure 14 of the first example.

In this second example, most of the parts are the same or similar to those described in relation to the first example above and are not again described here in detail. However, in this example, the locating body 112 includes two parts or portions including an outer body portion, part or boss 180 which is coupled to the lifting structure 114, and an inner or central body portion part or boss 181 which is received by and coupled to the outer body portion 180 so as to be rotatable relative to the outer body portion 180.

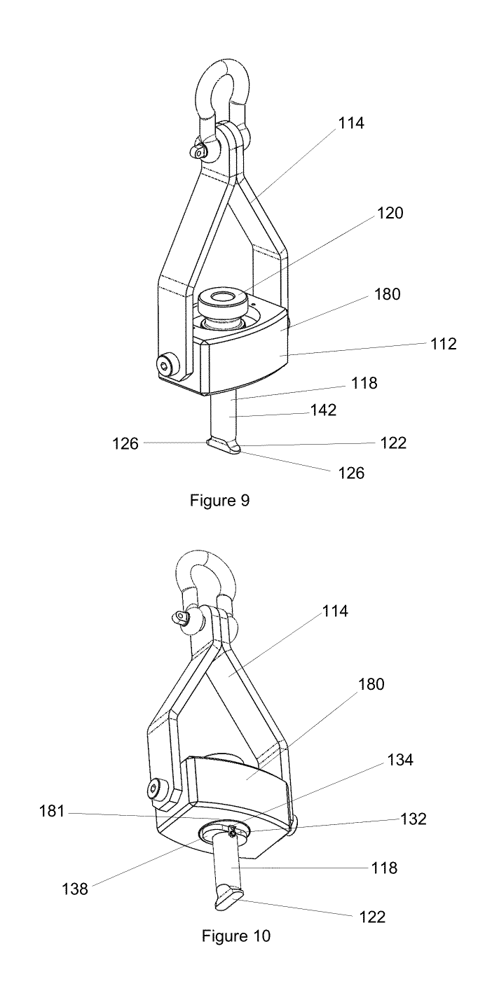

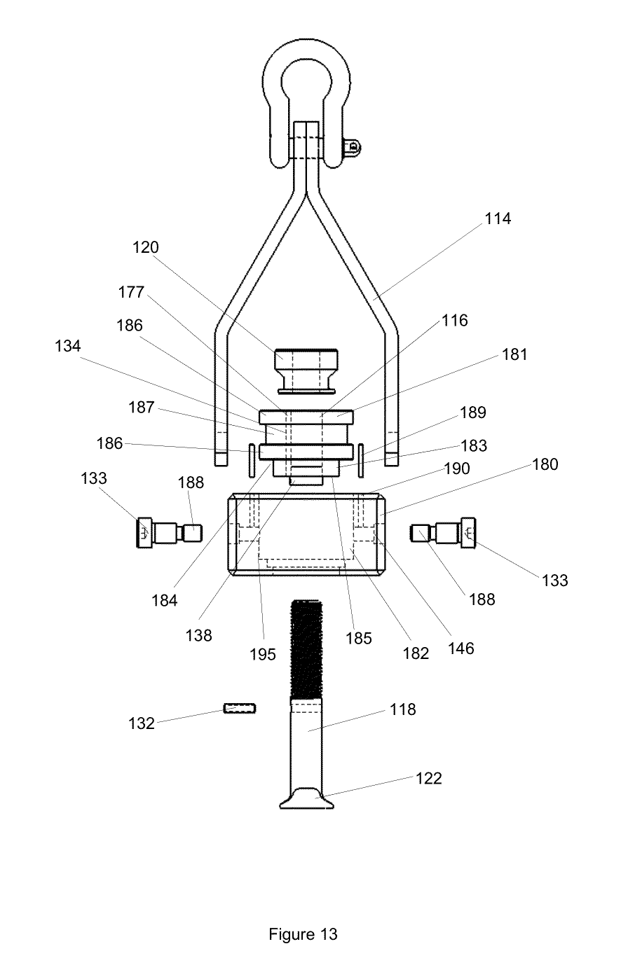

The inner body portion 181 includes the bore 116 located centrally of the inner body portion 181 and carries the lifting pin 118 within the bore 116 in a similar manner as that described in relation to the first example of the device 10. The inner body portion 181 also includes the projection or locator 138 fixed to and extending from the underside 185 of the inner body portion 181. The foot 122 of the pin 118 is slidably secured in a perpendicular orientation relative to the locator 138 with the locating lug 132 of the pin 118 being received by the guide slot 134 formed in this example along inner walls 177 of the central bore 116 of the inner body portion 181 as is best shown in FIG. 13. The actuator nut 120 may be then advanced on the pin 118 to move or slide the pin 118 in a lengthwise direction relative to the bore 116 between the retracted position as shown in FIGS. 7, 8 and 11, and the extended position as shown in FIGS. 9, 10 and 12.

In this example, the inner body portion 181 carries the locator 138 and lifting pin 118 including the foot 122 and, as such, the locator 138 and lifting pin 118 including the foot 122 rotate with one another. However, the locator 138 and lifting pin 118 including the foot 122 may rotate relative to the outer body 180 of the locating body 112. This rotation is advantageous, as the lifting structure 114 secured to the outer body portion 180 may rotate relative to the inner body portion 181 so as to allow the lifting structure 114 to align with an applied force whilst the inner body portion 181, in particular, the locator 138 and the lifting pin 118 including the foot 122 are coupled to a structure 59 such as a plate 60 as is further described below.

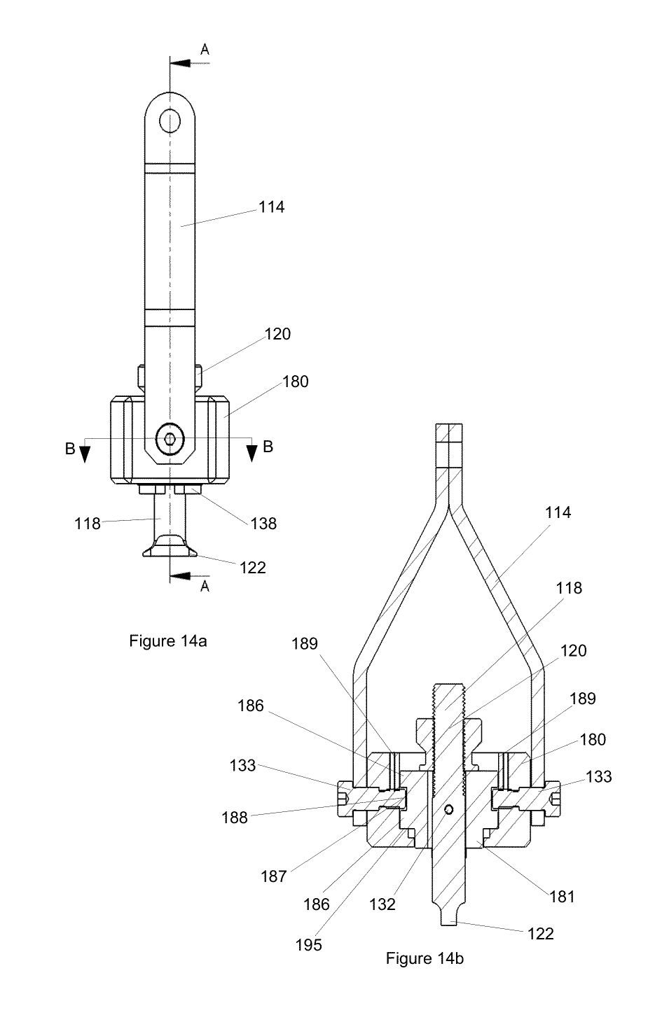

Referring now more specifically to FIGS. 13 to 15b, the outer body portion 180 includes an aperture 182 arranged to receive and support the inner body portion 181. The inner body portion 181 includes two spaced apart skirting rims 186 which define a circumferential recess 187 therebetween. The inner body portion 181 includes a neck 183 which necks inwardly and extends from the lower most of the skirting rims 186. The locator 138 projects or extends from the neck 183. The neck 183 provides stepped ledge 184 on the underside of the lowermost of the skirting rims 186. The ledge 184 is rotatably seated in an assembled condition, as shown in FIG. 14b, on a corresponding stepped seat 195 of the aperture 182 of the outer body portion 180.

The circumferential recess 187 receives ends 188 of the threaded fasteners 133 which extend through apertures 146 the outer body portion 180. The ends 188 and the circumferential recess 187 are rounded and are arranged to clear or slide past one another (as is best shown in FIG. 14b) so as to allow rotation of the inner body portion 181 relative the outer body portion 180 about an axis aligned with the pin 118. However, the ends 188 are captured by the skirting rims 186 which serve to releasably retain the inner body portion 181 within the outer body portion 180 so as to inhibit or lock the inner body portion 181 from movement in a direction aligned with the axis of the pin 118. The outer body portion 180 includes locking pins 189 which pass through corresponding apertures 190 of the outer body portion 180 so as to meet with and engage the ends 188 of the threaded fasteners 133 thereby securing the threaded fasteners 133 in place. The ends 188 may include a threaded aperture (not shown) to engage and secure the locking pins 189.

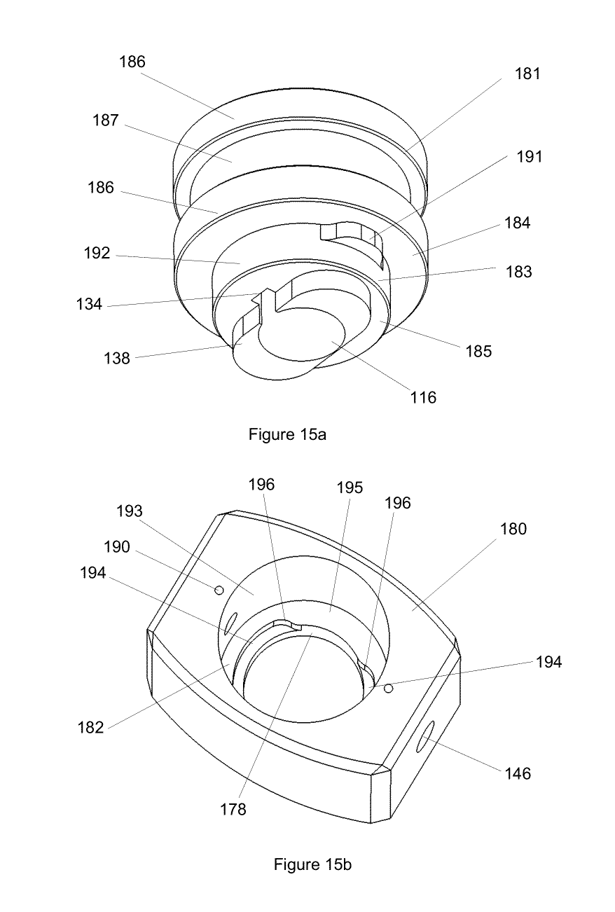

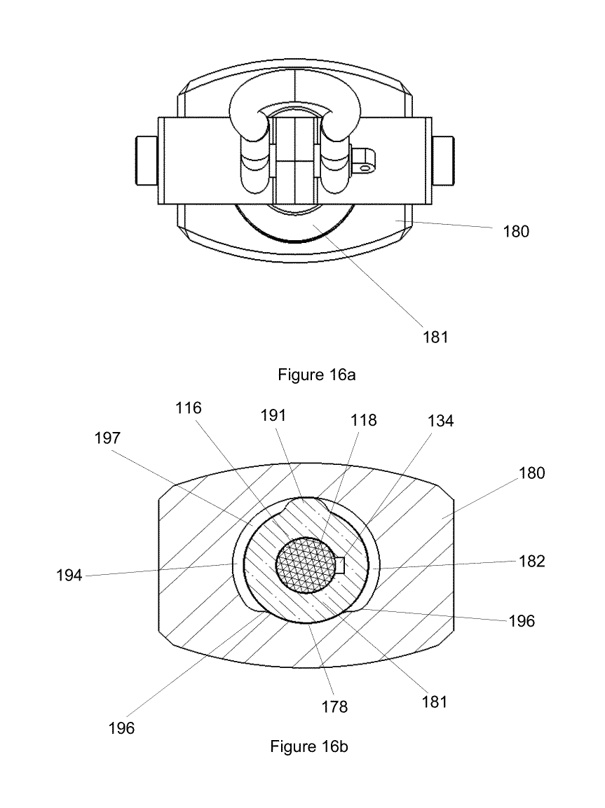

Referring now more specifically to FIGS. 15a to 16b, the inner body portion 181 includes a knob or stop 191 which projects from a generally circular outer surface 192 of the neck 183 of the inner body portion 181. The aperture 182 of the outer body portion 180 has is shaped and arranged to allow rotation of the inner body portion 181 through an angle of about 180 to 270 degrees, or about 90 to 120 degrees either side of a neutral position as is best shown in FIG. 16b.

More specifically, the aperture 182 includes an upper receiving portion 193 which steps inwardly at stepped seat 195 to a lower receiving portion 178. The upper receiving portion 193 is shaped to fit with, guide and receive the circular outer surface 192 of skirting rims 186 of the inner body portion 181, and the lower receiving portion 178 is shaped to fit with, guide and receive the circular outer surface 192 of the neck 183.

The stepped seat 195 includes a cut-out or recess 194 which provide a space or gap 197 in which the knob 191 carried by the inner body portion 181 is able to travel. The recess 194 extends around between about 180 degrees and 270 degrees of the stepped seat 195 and terminates at end stops or end ledge 196 against which the knob 191 abuts or engages at the end of travel or rotational limits as is best shown in FIG. 16b.

Accordingly, in this example, the relative rotation of the inner body portion 181 located within the outer body portion 180 is limited by the interference or engagement of knob or stop 191 and the end stops 196 to about less than 180 to 270 degrees.

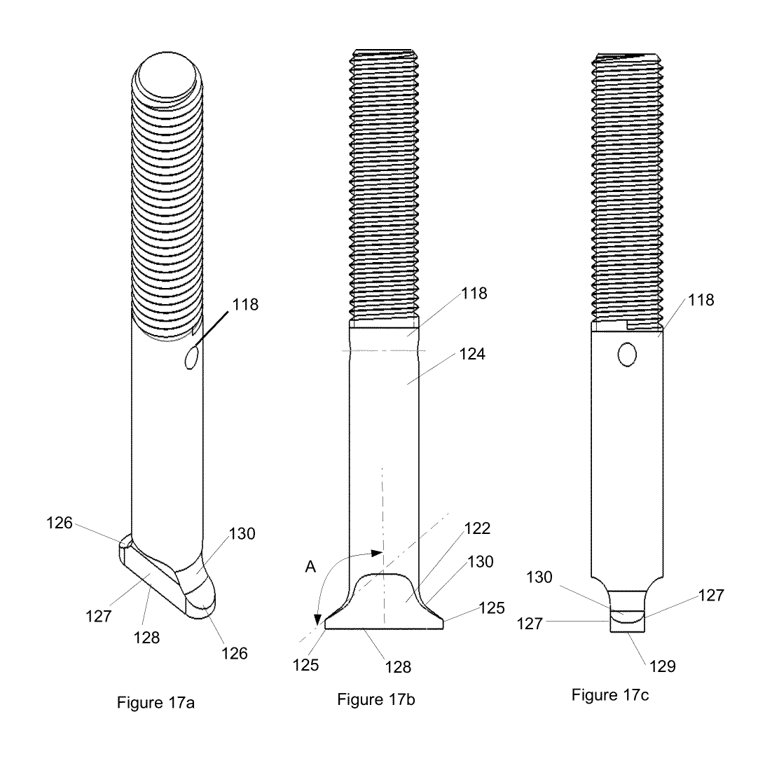

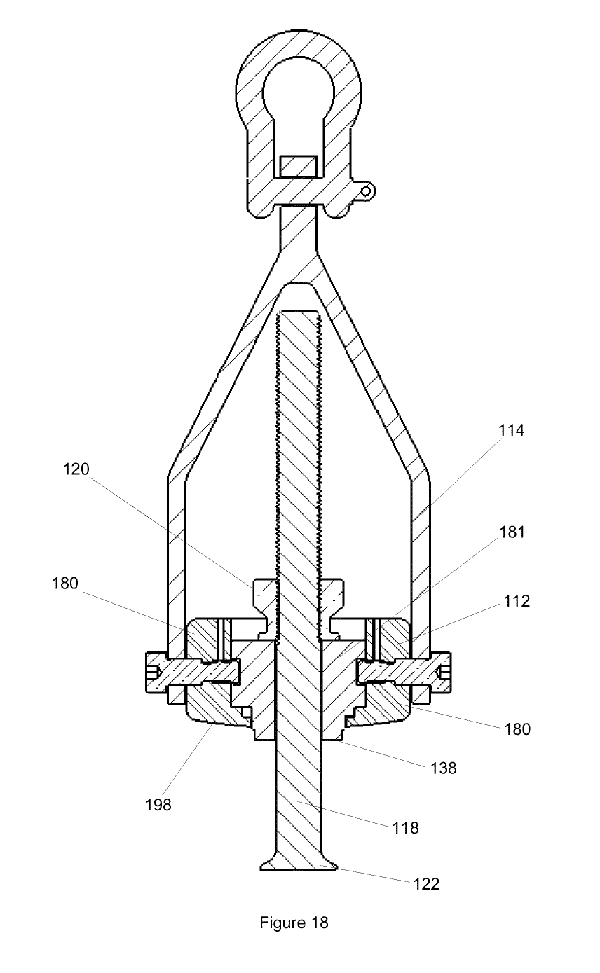

Referring to FIGS. 17a to 17c, the lifting pin 118 is shown in more detail. Similarly to the first example, the foot 122 has a generally elongate shape having a central portion 128 and wings 126 extending from opposing sides of the central portion 128. The wings 126 provide the foot 122 with abutment surfaces 130. The free ends 125 of the wings 126 are rounded and the opposing sides 127 of the foot 122 are straight. The base 129 of the foot 122 presents a generally flat surface.

The length of the foot 122 between the free ends 125 of the wings 126 is greater than the diameter of the shank 124. It is noted that in this example the length of the foot 122 is about 35 mm and the width of the foot 122 is about 10 mm. The diameter of the shank 124 of the lifting pin 118 is about 20 mm and may be formed from a machined M20 (metric 20 mm diameter) bolt. The length of the foot 122 therefore being about 1.75 times the diameter of the shank 124 and the width of the foot 122 being about half the diameter of the shank 124.

The wings 126 of the foot 122, which provide the abutment surfaces 130, taper or chamfer inwardly to join the shank 124. The angle “A” of the taper is about 120 degrees from the vertical axis of the lifting pin 118. The overall length of the lifting pin 118 is 125 mm. The width of the foot 122 between the opposing sides 127 is narrower than the diameter of the shank 124 and the foot 122 tapers or chamfers outwardly from the opposing sides 127 to the shank 124. The size and shape of the aperture or hole 62 (as described below) and the other components of the lifting device 110 are sized and shaped accordingly to fit with the pin 118. Alternatively, the lifting pin 118 and foot 122 are sized and shaped to fit with the aperture or hole 62 (as described below).

Referring to FIG. 18, in some examples, the device 110 may include a curved or convex shaped underside of the body portion 112. In particular, in this example, the outer body portion 180 includes a convex underside surface 198 which allows the device 110 to better fit with likewise curved or non-flat structures such as plate structures 60 as are further described below. The device 110 may also have a longer pin 118 so as to fit with plate structures 60 or varying thickness or to fit with other structures where a longer reach is required.

The device 110 including the body 112, the pin 116 and the lifting device 114 may be made from a metal or steel material, preferably, high tensile steel. In this example, the lifting capacity is in the order of about 300 to 1500 kg. However, other variations may have difference lifting capacities.

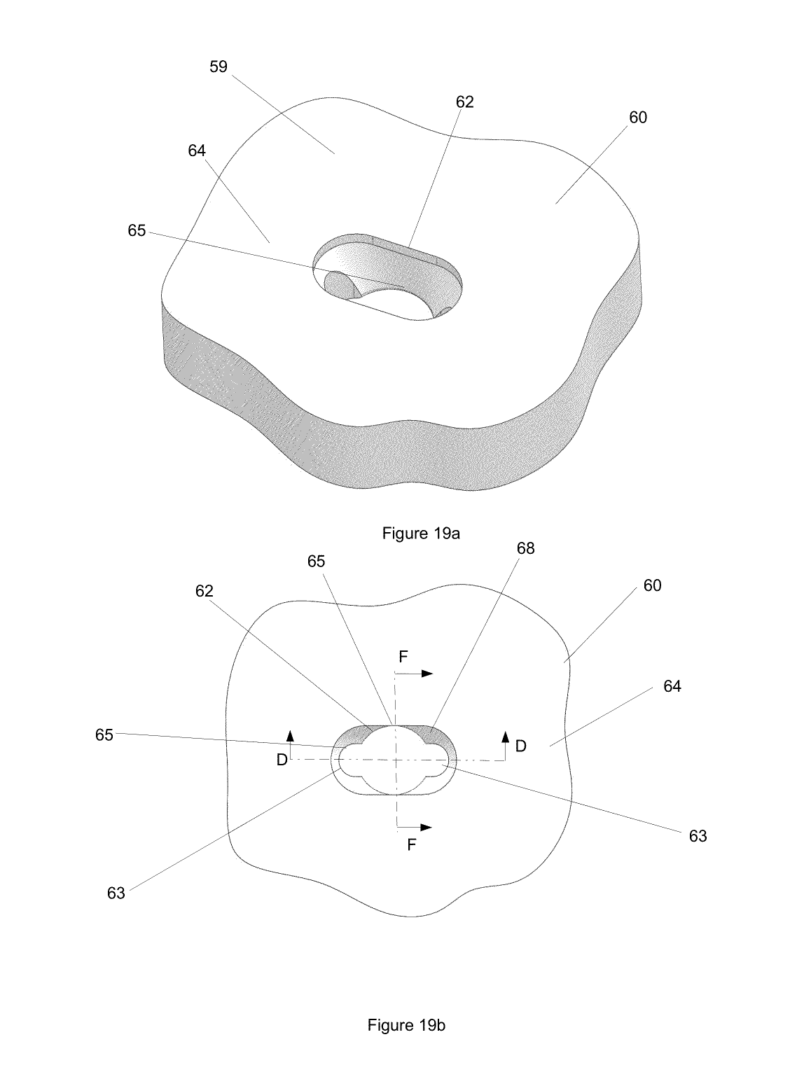

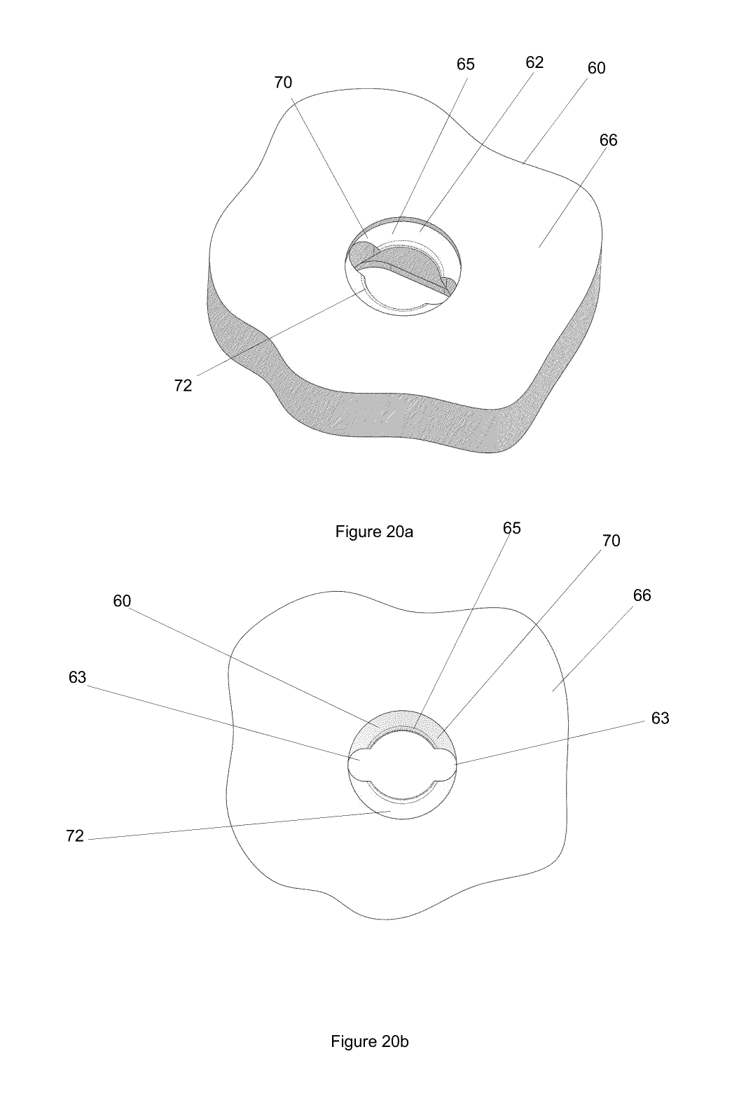

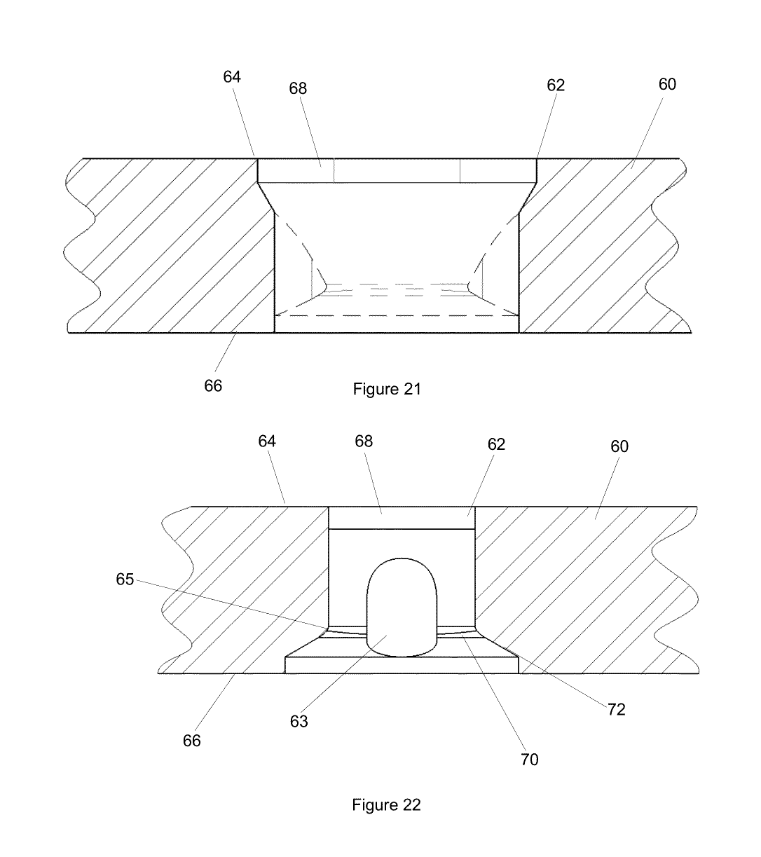

Referring to FIGS. 19a to 22, the device 10, 110 is adapted to couple with a structure 59 which is provided in this example in the form of a plate 60. The device 10, 110 provides an anchor point or lifting point for the plate 60. The plate 60 may be a cast liner or wear plate formed from a cast material such as a metallic based material. The plate 60 may have any suitable shape. It is noted that whilst the device 10, 110 is described herein as being preferably adapted to couple with the structure 59 in the form of the plate 60, the device 10, 110 may couple with any suitable structure or component in which the aperture 62 is formed or located. For example, various metal structures or components may be formed with the aperture formed or located in the metal structures or components to which the device 10, 110 may couple.

The plate 60 may be formed by a method including the steps of inserting a plug (not shown) shaped to define the aperture 60 within a cast and filling the cast with material to form the plate. The material may be metallic based material suitable or wear or liner plates. The plate 60 may also be formed by using a tool to machine the aperture 60 into the plate. In this case, the plate 60 is formed by, for example, casting the plate 60, and the aperture 62 is then cut into the plate 60 by a tool (not shown) configured to machine or cut the shape of the aperture 62 within the plate 60.

The plate 60 includes an aperture 62 which extends between a first or top side 64 of the plate 60 and a second or under side 66 of the plate 60. The aperture 62 and the lifting pin 18 are shaped to fit with one another such that the foot 22, 122 is able to pass through the aperture 60, from the top side 64 toward the under side 66, in a first orientation and be rotated to a second orientation in which the foot 22 is captured by the aperture 60. The aperture 62 includes an upper or receiving aperture portion 68 located toward the top surface 64 of the plate 60 and a lower or retaining aperture portion 70 located toward the under side 66 of the plate 60.

More specifically, in plan form, the aperture 62 includes a generally circular middle section or throat 65 and opposing side portions 63. The circular middle section or throat 65 is shaped to allow passage of the shank 42, 142 of the pin 18, 118 and the opposing side portions 63 are shaped to allow passage of the foot 22, 122, in particular, the wings 26, 126 of the foot 22, 122 in the first orientation. When the foot 22, 122 is moved past the throat 65 and then rotated within the lower aperture portion 70 to the second orientation and out of alignment with the opposing side portions 63, the throat 65 serves to retain the foot 22, 122 within the lower aperture portion 70 as is further described below. Accordingly, the throat 65 is located between the upper or receiving aperture portion 68 and the lower or retaining aperture portion 70.

The upper aperture portion 68 and the projecting portion or locator 38, 138 of the body 12, 112 are shaped to fit with one another such that the projecting portion 38, 138 of the body 12, 112 is receivable within the upper aperture portion 68. Accordingly, the upper aperture portion 68 has a generally oval shape that fittingly receives the likewise oval shape of the projecting portion 38, 138.

The lower aperture portion 70 is shaped to receive the foot 22, 122 of the pin 18, 118 when the device 10, 110 is fitted to the plate 60. The lower aperture portion 70 is generally circular in shape at the underside 66 and necks inwardly at abutment surfaces 72 to form the throat 65 between the upper aperture portion 68 and the lower aperture portion 70. The abutment surface 72 being provided on an underside of the throat 65. The inward necking, radius or chamfer provides the abutment surface 72 which is configured or shaped to abut with the foot 22, 112, in particular, the corresponding abutment surfaces 30 of the foot 22, 112 when the device 10, 110 is attached to the plate 60.

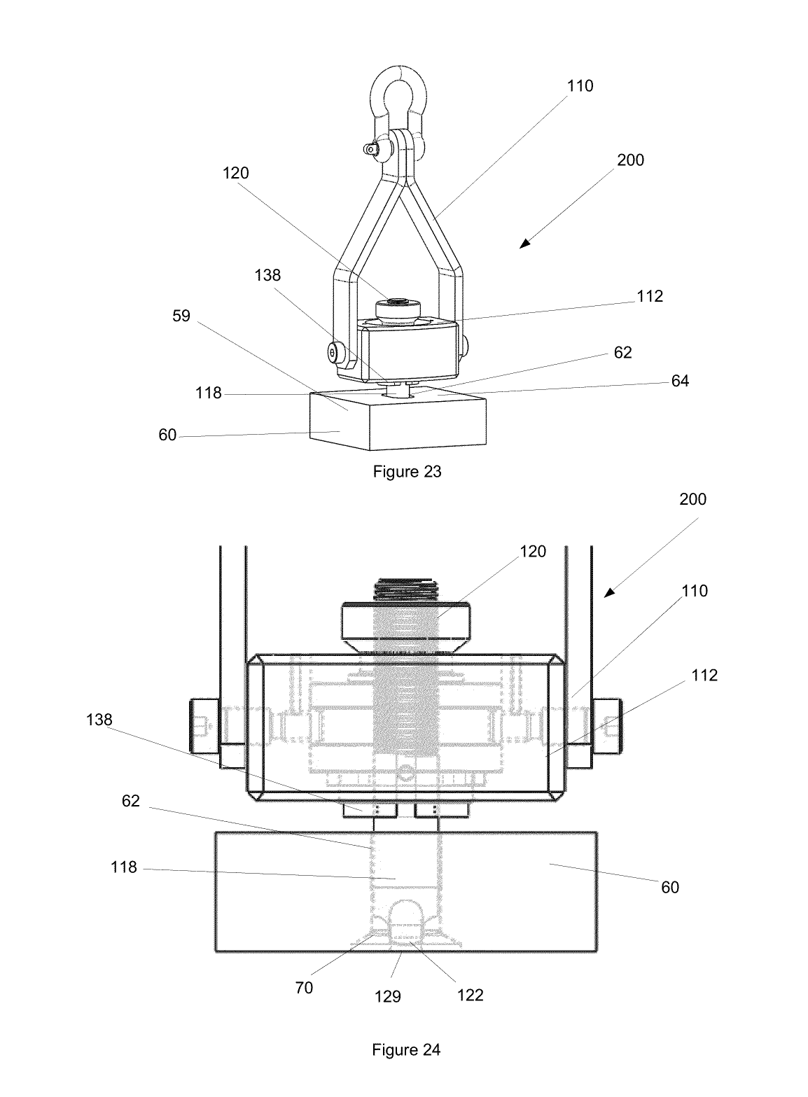

Importantly, the lower aperture portion 70 provides sufficient space or headroom to allow the foot 22, 112 to be rotated within the lower aperture portion 70 between the first orientation and the second orientation whilst the underside 66 of the plate 60 is lying against a surface such as a ground surface. The more specific aspects of the fitting of the plate 60 and the device 10, 110 and the method of operation are now further detailed below with reference with FIGS. 23 to 26.

In this example, the aperture 62 may be sized and shaped to fit with the pin 118 as has been described above in relation to FIGS. 17a to 17c. Accordingly, the diameter of the throat 65 is about or slightly greater than 20 mm to received the shank 124 of the pin 118 and the length between the opposing side portions 63 is about or slightly greater than 35 mm to allow passage of the foot 122. Accordingly, the dimensional ratio between the throat 65 diameter and the length between the opposing side portions 63 is about 1 to 1.75. The width of the opposing side portions 63 is arranged to accommodate the width of this foot 122 and is therefore the about half o of the throat 65 diameter which in this example is about or slightly greater than 10 mm. The thickness of the plate 60 may be about 20 mm to 60 mm. However, other sizes and shapes may also be utilised depending on the specific application.

It is noted that a section of the plate 60 is shown here having a single aperture 62. However, the plate 60 may include a plurality of the apertures 62 at spaced apart locations to allow coupling or connection of multiple lifting devices 10, 110 to the plate 60. The location of a plurality of the apertures 62 at spaced apart and pre-determined locations allows for load points to be pre-determined to allow for safe and balanced lifting of the plates 60.

Referring now to FIGS. 22 and 26, there is shown a system 200 including the lifting device 110 and the plate 60. In this example, the second example of the device 110 is illustrated. However, the system 200 and any associated methods may also include or involve the first example of the lifting device 10.

A method to fit the device 110 to the plate 60 is now described. The pin 118 of the device 110 is moved to the extended position by rotating the actuator nut 20. The plate 60 is typically lying on the ground with the upper side 64 facing upwardly. The foot 122 is then passed through the aperture 62 in the first orientation. The base 129 of the foot 22 may then come to rest on the ground surface on which the plate 60 is lying. The foot 122 is now located in the lower aperture portion 70 and in a released condition in which the foot 122 is freely rotatable within the lower aperture portion 70. In the first orientation, the projecting portion or locator 38 is not able to be received by the aperture 62 and may be rested or seated on the top side 64 of the plate 60

The foot 122 may now be rotated to the second orientation which in this example is perpendicular to the first orientation. The rotation of the pin 118 and the inner body portion 181 (the body 12 in the first example) are locked with each other by the locating lug 32 and the corresponding guide slot 34. Accordingly, rotation of the foot 22 of the pin 18 between first orientation and the second orientation requires rotation of the inner body 181, relative to the outer body 182, between the first orientation and the second orientation. It is noted that in the first example, the method slightly is different and the rotation of the foot 22 of the pin 18 between the first orientation and the second orientation requires rotation of the entire body 12 between the first orientation and the second orientation.

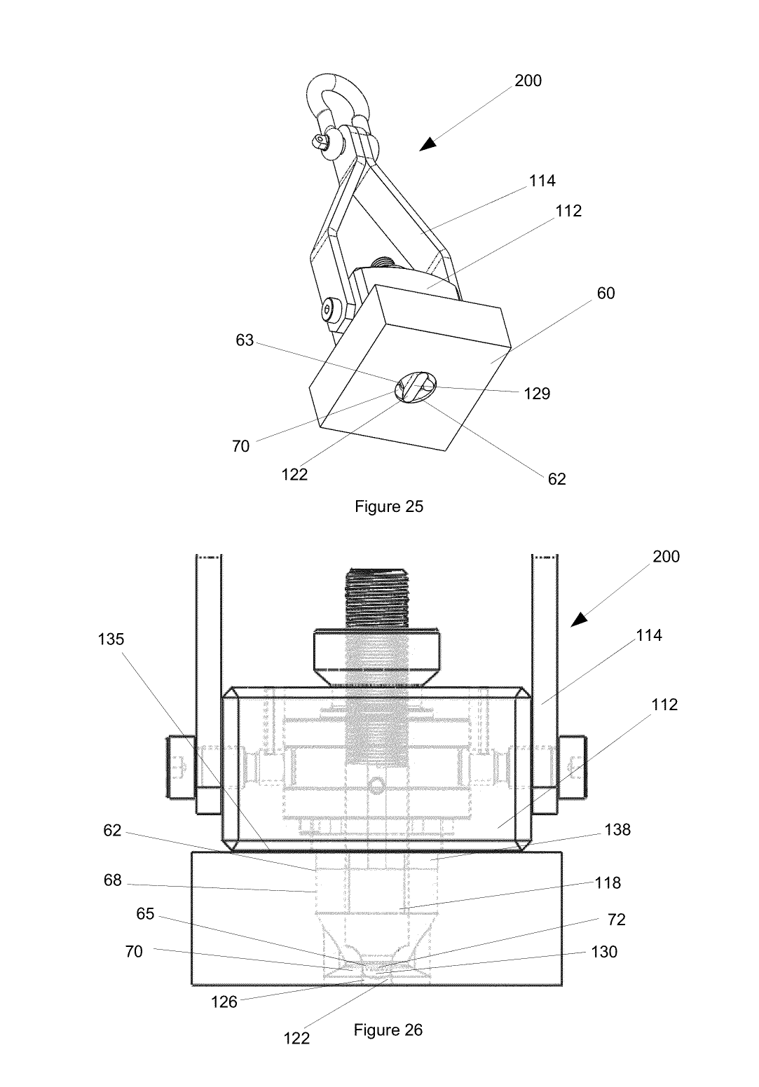

The projecting portion or locator 138 of the body 112 is shaped to fit with and be received by the upper aperture portion 68 in the second orientation. Accordingly, when the foot 122 is rotated to the second orientation, the projecting portion 138 aligns and is received by upper aperture portion 68 as is shown in FIGS. 25 and 26. In this position, the underside 135 of the body 112 is seated on or abutted with the top side 64 of the plate 60.

In the second orientation, the projecting portion 38 or locator is located within the aperture 62 and the foot 122, in particular the abutment surfaces 130 of the foot 22, are aligned for engagement with the abutment surfaces 72 of the lower aperture portion 70. The actuator nut 120 may be then advanced on the pin 118 to move or slide the pin 118 in a lengthwise direction relative to the bore 116 between a disengaged condition and an engaged condition which requires movement of the pin 118 between the extended and retracted positions.

In the engaged condition, the actuator nut 120 is advanced on the pin 118 to draw or raise the foot 122, in the second orientation, into engagement with the aperture 62 of the plate structure 60. This moves the pin 118 from the extended position to the retracted position.

In particular, in the engaged condition abutments surfaces 130 on top of the wings 126 of the foot 122 are drawn into abutment with the underside of the throat 65, more specifically the corresponding abutment surfaces 72 of the lower aperture portion 70. The underside 135 of the body 112 is abutted against a top side 64 of the plate 60 and the projecting portion 38 is received by the upper aperture portion 68. Accordingly, in the engaged condition, the plate 60 is clamped between the foot 122 and the body 112 of the device 10. In the second example of the device 110, in the engaged condition, the inner body portion 181 may rotate relative to the outer body portion 180 which ultimately allows the lifting structure 114 to swivel as well as pivot via the fasteners 133 relative to the plate 60. However, in the first example of the device, in the engaged condition, the body 112 which directly carries the locator 138 is locked against rotation and therefore the lifting structure 14 is inhibiting from swivelling but may still pivot or hinge via the fasteners 133.

In the disengaged condition, the pin 118 is moved to the extended position in which the actuator nut 120 is rotated to extend the foot 122 away from the body 112. This allows the foot 122 to be freed from the corresponding abutment surfaces 72 of the lower aperture portion 70 and also allows the removing or freeing of the projecting portion 38 from the aperture 62. Once the foot 122 and the projecting portion 138 are free, the foot 122 may be rotated to the first orientation. This allows the foot 122 to pass through the aperture 62 and allows the decoupling of the device 10 from the plate 60.

It is noted the size and shape of the devices 10, 110 may be varied to fit with plates 60 of varying thicknesses and having apertures 62 of varying shapes and depths within or through the plate 60. Example size and shape proportions of the device 10, 110 and the plate 60 are apparent from the Figures. However, other suitable proportions may also be applied and are encompassed by the scope of the invention disclosed herein.

Advantageously, there has been described herein a device, a plate, a system including the device and the plate and associated method of use which allows for the safe and secure lifting of a plate having an aperture in the plate.

In particular, the device and the aperture of the plate are configured to securely couple with one another so as to allow the device to be coupled with the plate when the plate is lying flat on a surface such as a ground surface or when multiple plates are stacked in a substantially horizontal orientation on top of one another. This allows the plate to be lifted and lowered in a substantially flat orientation without needing to raise an edge or clasp an edge of the plate.

In the first disclosed example, the device is configured to interlock with the aperture in a preferred orientation, described herein as the second orientation, in which the rotation of the device is locked relative to the plate and the pin of the device is secured via the actuator nut in an engaged condition to clamp or lock the device to the aperture and hence the plate.

In the second disclosed example, the device includes a two part body having an outer body portion and a rotatable inner portion which carries the pin. The device is configured to interlock with the aperture in a preferred orientation, described herein as the second orientation, in which the device is locked to the plate via the pin but the outer body portion is still able to swivel or rotate about the inner body portion and aperture of the plate to which the inner body portion is coupled.

The device is then releasable by moving the actuator nut to move the pin to the disengaged condition in which the locator is removable from the plate which allows rotation to the first orientation in which the pin is removable from the aperture of the plate and hence the device is decoupled from the plate.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any known matter or any prior publication is not, and should not be taken to be, an acknowledgment or admission or suggestion that the known matter or prior art publication forms part of the common general knowledge in the field to which this specification relates.

While specific examples of the invention have been described, it will be understood that the invention extends to alternative combinations of the features disclosed or evident from the disclosure provided herein.

Many and various modifications will be apparent to those skilled in the art without departing from the scope of the invention disclosed or evident from the disclosure provided herein.

The claims defining the invention are as follows:

1. A device for lifting a structure having an aperture therein, the device including a body adapted to locate the device relative to the aperture of the structure and a pin moveably receivable by a bore of the body, the pin including a foot which is arranged to pass through the aperture of the structure in a first orientation and be rotated to a second orientation such that the foot is engagable with the aperture of the structure.

2. The device according to claim 1, wherein the body includes a locator arranged to be receivable by the aperture of the structure.

3. The device according to claim 2, wherein the locator and foot are each substantially elongate in shape and are oriented substantially perpendicular to one another.

4. The device according to claim 2, wherein the locator is shaped to fit with the aperture so as to inhibit rotation of the body relative to the structure.

5. The device according to claim 2, wherein the pin and the bore are adapted to fit with one another so as to inhibit rotation of the pin relative to the bore.

6. The device according to claim 5, wherein one of the bore and the pin includes a guide slot and the other of the bore and pin includes a lug received by the guide slot, the guide slot and lug being arranged to allow lengthwise slidable movement of the pin relative to the bore and inhibit rotation of the pin relative to the bore.

7. The device according to claim 5, wherein the body includes an outer body portion and an inner body portion rotatably coupled to the outer body portion, wherein the inner body portion includes the bore and the locator thereby allowing rotation of the bore and locator relative to the outer body portion.

8. The device according to claim 7, wherein the inner body portion and outer body portion are shaped to engage with one another at rotational limits thereby allowing limited relative rotation of the inner body portion and the outer body portion between the rotational limits.

9. The device according to claim 1, further including an actuator coupled to the pin so as to move the pin lengthwise relative to the bore between a disengaged condition, in which the pin is in an extended position and the foot is removable in the first orientation from the aperture of the structure, and an engaged condition, in which the pin is moved to a retracted position and the foot is movable in the second orientation into engagement with the aperture of the structure.

10. The device according to claim 9, wherein the actuator is a nut threadedly coupled to the pin.

11. The device according to claim 1, wherein the pin has a substantially elongate cylindrical shape and the foot includes wings which extend from opposing sides of the pin.

12. The device according to claim 1, wherein a lifting structure is coupled to the body.

13. The device according to claim 12, wherein the lifting structure includes a wishbone with ends of the wishbone being pivotally coupled to opposing sides of the body such that the pin is accessible between the ends of the wishbone.

14. A lifting system including a lifting device as defined in claim 1 and a plate having an aperture therein, wherein the aperture is shaped to receive the foot of the pin in the first orientation and restrict the passage of the foot in the second orientation.

15. The lifting system of claim 14, wherein the aperture includes internal abutment surfaces which are arranged to be engagable with corresponding abutment surfaces of the foot in the second orientation.

16. The lifting system according to claim 15, wherein the aperture includes an upper aperture portion shaped to fit with a locator of the body so as to locate the body relative to the plate, and a lower aperture portion shaped to allow rotation of the foot between the first orientation and the second orientation whilst the foot is received within the lower aperture portion.

17. The lifting system according to claim 16, wherein the upper aperture portion is shaped to receive the body such that rotation of the locator relative to the plate is inhibited and wherein the internal abutment surfaces are provided on an underside of a throat defined between the upper aperture portion and the lower aperture portion.

18. A plate for coupling with a device as defined in claim 1, the plate including a top surface, an underside surface and an aperture which extends between the top surface and the underside surface, wherein the aperture is adapted to allow passage of the foot in the first orientation and be engagable with the foot in the second orientation.

19. The plate according to claim 18, wherein the aperture includes a receiving portion toward the top surface and a retaining portion located toward the bottom surface relative the receiving portion, wherein the receiving portion is arranged to receive the body so as to locate the body relative to the plate and the retaining portion is arranged to allow rotation of the foot between the first orientation and the second orientation whilst the foot is received within the lower aperture portion.

20. The plate according to claim 19, wherein a throat is defined between the receiving portion and the retaining portion, the throat having abutment surfaces which are engageable with abutment surfaces of the foot in the second orientation.
